(19) United States
(12) Patent Application Publication
(10) Pub. No.: US 2024/0314795 A1
(43) Pub. Date: Sep. 19, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/676,511

(22) Filed: May 29, 2024

Related U.S. Application Data
(63) Continuation of application No. PCT/CN2022/136426, filed on Dec. 5, 2022.

(30) Foreign Application Priority Data
Dec. 10, 2021 (CN) 202111503797.3

(51) Int. Cl. H04W 72/23; H04L 5/00; H04W 48/16; H04W 76/11

(52) U.S. Cl. CPC H04W 72/23; H04L 5/0005; H04W 48/16; H04W 76/11

(57) ABSTRACT

The node firstly receives a first signaling, the first signaling indicating scheduling activation, the first signaling being identified by an RNTI of first type; and receives a first information block, the first information block being used to determine whether at least one CORESET is associated with a first identity or a second identity; and determines whether to perform the scheduling activation indicated by the first signaling in at least first time-frequency resource set according to at least the first information block; performs a first operation in the at least first time-frequency resource set upon determination of performing the scheduling activation indicated by the first signaling, or doesn't perform the first operation upon determination of not performing the scheduling activation indicated by the first signaling; each of the first identity and the second identity identifies one cell. This application improves the criterion for semi-persistent transmission suspension to optimize system performance.

### CROSS REFERENCE TO RELATED APPLICATIONS

This application is the continuation of the international patent application No.PCT/CN2022/136426, filed on Dec. 5, 2022, and claims the priority benefit of Chinese Patent Application No. 202111503797.3, filed on Dec. 10, 2021, the full disclosure of which is incorporated herein by reference.

### BACKGROUND

### Technical Field

The present application relates to transmission methods and devices in wireless communication systems, and in particular to a transmission scheme and device for semi-persistent or configured scheduling in wireless communications.

### Related Art

In 5G New Radio (NR), Massive Multi-Input Multi-Output (MIMO) is a key technology. In Massive MIMO, multiple antennas form through Beamforming a narrow beam pointing in a specific direction to enhance communication quality. In 5G NR, a base station can update a Transmission Configuration Indication (TCI) used by a terminal for receiving a Physical Downlink Control Channel (PDCCH), as well as a TCI used for receiving a Physical Downlink Shared Channel (PDSCH) through one or more Medium Access Control (MAC) Control Elements (CE) or dynamic signaling, thus ensuring the performance gains brought about by beamforming. Similarly, the base station can update via a piece of Downlink Control Information (DCI) the Quasi Co-located (QCL) parameters used by multiple different types of physical layer channels or QCL parameters on multiple carriers to reduce signaling overhead.

As discussed in NR R17, the subject of Inter-cell Operation targeting the Multi-TRP scenario is on hot debate, where at the RANI #104b-e conference, an extra Physical Cell Identity (PCI) different from a PCI of Serving Cell is being introduced.

### SUMMARY

In existing NR systems, the base station performs Activation or Deactivation/Release of the downlink Semi-Persistent Scheduling (SPS) or the uplink Type 2 Configured Scheduling (CS) by means of the PDCCH identified by a special Radio Network Temporary Identifier (RNTI). However, in the M-TRP scenario, the base station may update the QCL relationship of the Physical Downlink Shared Channel (PDSCH) received by the UE or the Physical Uplink Shared Channel (PUSCH) transmitted by the UE; further, there is a scenario in which the updated QCL relationship switches from being associated with a serving cell PCI to being associated with a non-serving cell PCI, and thus when an SPS configuration or a CS configuration spans two TCI states that are respectively associated with different PCIs, how to handle the above SPS configuration or CS configuration needs to be reconsidered.

To address the above problem of non-dynamic scheduling in M-TRP scenarios, the present application discloses a solution. It should be noted that in the description of the present application, M-TRP is only used as a typical application scenario or example; the present application is equally applicable to other scenarios facing similar problems, such as single-TRP scenarios, or scenarios of joint collaboration between multiple base stations, or base stations or user equipment with enhanced capabilities, or for different technical fields, for instance, in addition to SPS or CS, it is also applicable for channel estimation, measurement, demodulation, etc. to achieve similar technical results. Additionally, the adoption of a unified solution for various scenarios, including but not limited to M-TRP scenario, contributes to the reduction of hardcore complexity and costs. In the case of no conflict, the embodiments of a first node and the characteristics in the embodiments may be applied to a second node, and vice versa. Particularly, for interpretations of the terminology; nouns, functions and variables (unless otherwise specified) in the present application, refer to definitions given in TS36 series, TS38 series and TS37 series of 3GPP specifications.

The present application provides a method in a first node for wireless communications, comprising:
receiving a first signaling, the first signaling indicating scheduling activation, the first signaling being identified by a first RNTI, the first RNTI being an RNTI of first type; and receiving a first information block, the first information block being generated at a protocol layer below RRC layer, the first information block being used to determine whether at least one Control Resource Set (CORESET) is associated with a first identity or a second identity; and
determining whether to perform the scheduling activation indicated by the first signaling in at least first time-frequency resource set according to at least the first information block; performing a first operation in the at least first time-frequency resource set according to indication of the first signaling upon determination of performing the scheduling activation indicated by the first signaling in the at least first time-frequency resource set, or not performing the first operation in the at least first time-frequency resource set upon determination of not performing the scheduling activation indicated by the first signaling in the at least first time-frequency resource set;
herein, each of the first identity and the second identity identifies one cell.

In one embodiment, the method above is characterized in that a determination is made as to whether a current SPS or CS process needs to be suspended based on whether the reference signal indicated by a Unified TCI is associated with a serving cell's PCI or a PCI other than the serving cell's PCI.

According to one aspect of the present application, comprising:
receiving a first message, the first message being used to configure at least one RNTI;
herein, the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.

According to one aspect of the present application, when the at least one RNTI includes/include the RNTI of first type, it is determined that the scheduling activation indicated by the first signaling is performed in the at least first time-frequency resource set; when the at least one RNTI does/do not include the RNTI of first type, whether to perform the scheduling activation indicated by the first signaling in the at least first time-frequency resource set is determined according to at least the first information block.

In one embodiment, the method above is characterized by: determining, based on whether the UE is configured with a plurality of RNTIs for SPS transmissions or CS transmissions that are associated with different PCIs, whether it is necessary to suspend the SPS transmissions or the CS transmissions when the reference signal indicated by a Unified TCI changes from being associated to a serving cell's PCI to being associated to a PCI other than the serving cell's PCI.

According to one aspect of the present application, when the first information block is used to determine that the at least one CORESET is associated with the first identity, it is determined that the scheduling activation indicated by the first signaling is performed in the at least first time-frequency resource set; when the first information block is used to determine that the at least one CORESET is associated with the second identity, it is determined that the scheduling activation indicated by the first signaling is not performed in the at least first time-frequency resource set.

According to one aspect of the present application, comprising:
receiving a second information block after the first information block;
herein, the second information block is generated at a protocol layer below RRC layer, the second information block being used to determine that at least one CORESET is associated with the first identity; the first information block is used to determine that at least one CORESET is associated with the second identity; and at least the first information block is used to determine that the scheduling activation indicated by the first signaling is not performed in the at least first time-frequency resource set; the second information block is used to determine that the scheduling activation indicated by the first signaling is performed after a second effective time, and the second information block is used to determine the second effective time.

In one embodiment, the method above is characterized in that when the reference signal indicated by the Unified TCI changes from being associated to the serving cell's PCI to being associated to a PCI other than the serving cell's PCI, the UE suspends the SPS transmission or the CS transmission; and when the reference signal indicated by the Unified TCI subsequently changes again from being associated to a PCI other than the serving cell's PCI to being associated to the serving cell's PCI, the UE again resumes the SPS transmission or the CS transmission that has been suspended as described above.

According to one aspect of the present application, a second signaling comprises the first information block, and the second signaling also comprises a first field; the first field of the second signaling is used to indicate a Hybrid Automatic Repeat reQuest (HARQ) process number used by a radio signal scheduled by the second signaling, or the first field of the second signaling is used to indicate a Redundancy Version (RV) used by a radio signal scheduled by the second signaling; and the first field is not used to suspend or deactivate a PDCCH Validation.

According to one aspect of the present application, comprising:
transmitting a third signaling;
herein, the third signaling is used to determine the first information block, the first information block being used to determine a first effective time, a position of the first effective time in time domain relating to time-domain resources occupied by the third signaling.

The present application provides a method in a second node for wireless communications, comprising:
transmitting a first signaling, the first signaling indicating scheduling activation, the first signaling being identified by a first RNTI, the first RNTI being an RNTI of first type; and transmitting a first information block, the first information block being generated at a protocol layer below RRC layer, the first information block being used to determine whether at least one CORESET is associated with a first identity or a second identity; and
determining whether to perform the scheduling activation indicated by the first signaling in at least first time-frequency resource set according to at least the first information block; performing a third operation in the at least first time-frequency resource set according to indication of the first signaling upon determination of performing the scheduling activation indicated by the first signaling in the at least first time-frequency resource set, or not performing the third operation in the at least first time-frequency resource set upon determination of not performing the scheduling activation indicated by the first signaling in the at least first time-frequency resource set;
herein, each of the first identity and the second identity identifies one cell.

According to one aspect of the present application, comprising:
transmitting a first message;
herein, the first message being used to configure at least one RNTI; the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.

According to one aspect of the present application, when the at least one RNTI includes/include the RNTI of first type, it is determined that the scheduling activation indicated by the first signaling is performed in the at least first time-frequency resource set; when the at least one RNTI does/do not include the RNTI of first type, whether to perform the scheduling activation indicated by the first signaling in the at least first time-frequency resource set is determined according to at least the first information block.

According to one aspect of the present application, when the first information block is used to determine that the at least one CORESET is associated with the first identity, it is determined that the scheduling activation indicated by the first signaling is performed in the at least first time-frequency resource set; when the first information block is used to determine that the at least one CORESET is associated with the second identity, it is determined that the scheduling activation indicated by the first signaling is not performed in the at least first time-frequency resource set.

According to one aspect of the present application, comprising:
transmitting a second information block after the first information block;
herein, the second information block is generated at a protocol layer below RRC layer, the second
information block being used to determine that at least one CORESET is associated with the first identity; the first information block is used to determine that at least one CORESET is associated with the second identity, and at least the first information block is used to determine that the scheduling activation indicated by the first signaling is not performed in the at least first time-frequency resource set; the second information block is used to determine that the scheduling activation indicated by the first signaling is performed after a second effective time, and the second information block is used to determine the second effective time.

According to one aspect of the present application, a second signaling comprises the first information block, and the second signaling also comprises a first field; the first field of the second signaling is used to indicate a HARQ process number used by a radio signal scheduled by the second signaling, or the first field of the second signaling is used to indicate an RV used by a radio signal scheduled by the second signaling; and the first field is not used to suspend or deactivate a PDCCH Validation.

According to one aspect of the present application, comprising:
receiving a third signaling;
herein, the third signaling is used to determine the first information block, the first information block
being used to determine a first effective time, a position of the first effective time in time domain relating to time-domain resources occupied by the third signaling.

The present application provides a first node for wireless communications, comprising:
a first receiver, receiving a first signaling, the first signaling indicating scheduling activation, the first signaling being identified by a first RNTI, the first RNTI being an RNTI of first type; and receiving a first information block, the first information block being generated at a protocol layer below RRC layer, the first information block being used to determine whether at least one CORESET is associated with a first identity or a second identity; and
a first transceiver, determining whether to perform the scheduling activation indicated by the first signaling in at least first time-frequency resource set according to at least the first information block; performing a first operation in the at least first time-frequency resource set according to indication of the first signaling upon determination of performing the scheduling activation indicated by the first signaling in the at least first time-frequency resource set, or not performing the first operation in the at least first time-frequency resource set upon determination of not performing the scheduling activation indicated by the first signaling in the at least first time-frequency resource set;
herein, each of the first identity and the second identity identifies one cell.

The present application provides a second node for wireless communications, comprising:
a first transmitter, transmitting a first signaling, the first signaling indicating scheduling activation, the first signaling being identified by a first RNTI, the first RNTI being an RNTI of first type; and transmitting a first information block, the first information block being generated at a protocol layer below RRC layer, the first information block being used to determine whether at least one CORESET is associated with a first identity or a second identity; and
a second transceiver, determining whether to perform the scheduling activation indicated by the first signaling in at least first time-frequency resource set according to at least the first information block; performing a third operation in the at least first time-frequency resource set according to indication of the first signaling upon determination of performing the scheduling activation indicated by the first signaling in the at least first time-frequency resource set, or not performing the third operation in the at least first time-frequency resource set upon determination of not performing the scheduling activation indicated by the first signaling in the at least first time-frequency resource set;
herein, each of the first identity and the second identity identifies one cell.

In one embodiment, the solution in the present application is advantageous in that the processing of SPS configurations or CS configurations after the effective time of the Unified TCI is determined based on the indication of the Unified TCI in the M-TRP scenario, thereby optimizing the system performance and avoiding unnecessary waste of resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a first signaling according to one embodiment of the present application.

FIG. 6 illustrates a flowchart of a first message according to one embodiment of the present application.

FIG. 7 illustrates a flowchart of performing a first operation according to one embodiment of the present application.

FIG. 8 illustrates a flowchart of performing a first operation according to another embodiment of the present application.

FIG. 9 illustrates a flowchart of not performing a first operation according to one embodiment of the present application.

FIG. 10 illustrates a flowchart of determining whether to perform the scheduling activation indicated by the first signaling according to one embodiment of the present application.

FIG. 11 illustrates a flowchart of determining whether to perform the scheduling activation indicated by the first signaling according to another embodiment of the present application.

FIG. 12 illustrates a flowchart of determining whether to perform the scheduling activation indicated by the first signaling according to a third embodiment of the present application.

FIG. 13 illustrates a flowchart of a second information block according to one embodiment of the present application.

FIG. 14 illustrates a flowchart of a third signaling according to one embodiment of the present application.

FIG. 15 illustrates a schematic diagram of an application scenario according to one embodiment of the present application.

FIG. 16 illustrates a structure block diagram of a processing device in a first node according to one embodiment of the present application.

FIG. 17 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

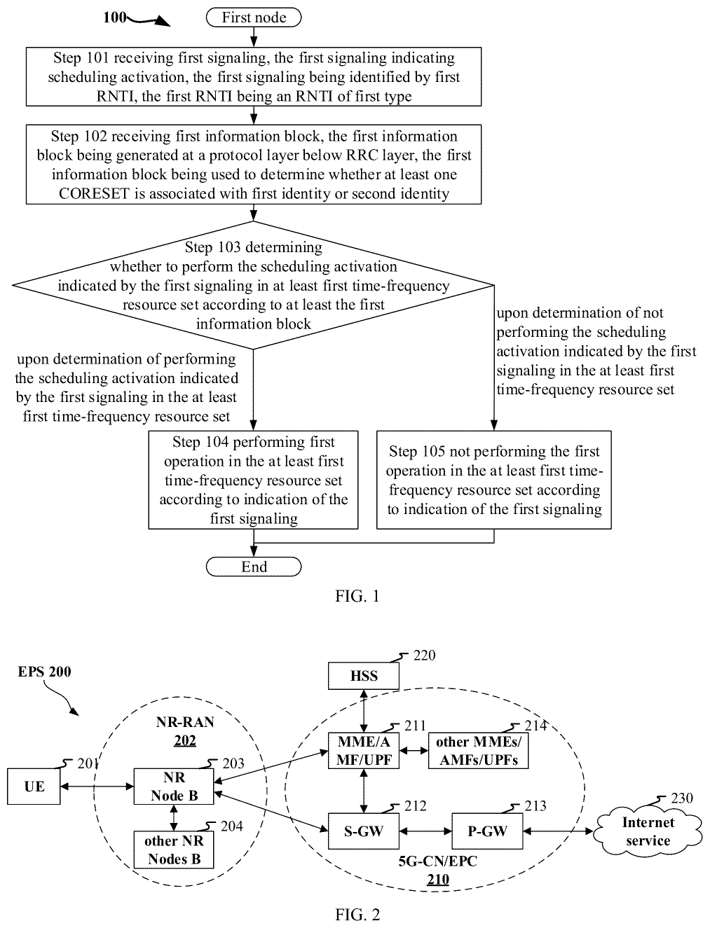

Embodiment 1 illustrates a flowchart of processing of a first node, as shown in FIG. 1. In 100 illustrated by FIG. 1, each box represents a step. In Embodiment 1, the first node in the present application receives a first signaling in step 101, the first signaling indicating scheduling activation, the first signaling being identified by a first RNTI, the first RNTI being an RNTI of first type; and receives a first information block in step 102, the first information block being generated at a protocol layer below RRC layer, the first information block being used to determine whether at least one CORESET is associated with a first identity or a second identity; and determines in step 103 whether to perform the scheduling activation indicated by the first signaling in at least first time-frequency resource set according to at least the first information block; and performs a first operation in the at least first time-frequency resource set according to indication of the first signaling in step 104 upon determination of performing the scheduling activation indicated by the first signaling in the at least first time-frequency resource set, or does not perform the first operation in the at least first time-frequency resource set in step 105 upon determination of not performing the scheduling activation indicated by the first signaling in the at least first time-frequency resource set.

In Embodiment 1, each of the first identity and the second identity identifies one cell.

In one embodiment, a physical layer channel occupied by the first signaling includes a PDCCH.

In one embodiment, the first signaling is a DCI.

In one embodiment, the first signaling is a PDCCH Validation.

In one embodiment, the first signaling is used to activate a Semi-Persistent Scheduling (SPS).

In one embodiment, the first signaling is used to activate a Configured Scheduling (CS).

In one embodiment, the first signaling is used to activate a Downlink (DL) SPS.

In one embodiment, the first signaling is used to activate a Type 2 Uplink Grant.

In one embodiment, the first signaling is used to activate a Type 2 Configured Grant Scheduling in Sidelink (SL).

In one embodiment, the first signaling is used to activate a semi-persistent Channel State Information (CSI).

Typically, the first signaling is transmitted in the at least one CORESET.

Typically, a search space in which the first signaling is present is associated with one of the at least one CORESET.

Typically, the first signaling and the first information block are used together to determine the first time-frequency resource set.

In one embodiment, the meaning of the sentence that the first signaling and the first information block are used together to determine the first time-frequency resource set comprises: the first signaling being used to activate a given SPS or a given CS, the given SPS or given CS being associated with a candidate time-frequency resource set, the first information block being used to determine a first effective time, the first time-frequency resource set being a portion of the candidate time-frequency resource set that lies after the first effective time.

In one embodiment, the meaning of the sentence that the first signaling and the first information block are used together to determine the first time-frequency resource set comprises: the first signaling being used to activate a given SPS or a given CS, the given SPS or given CS being associated with K1 time-frequency resource sets, K1 being a positive integer greater than 1, the first information block is used to determine a first effective time, and the first time-frequency resource set is one of the K1 time-frequency resource sets that lies after the first effective time.

Typically, the first information block is used to determine a first effective time, the first time-frequency resource set comprising a portion of the time-frequency resources indicated by the first signaling that lies after the first effective time.

In one embodiment, the first time-frequency resource set occupies more than one RE.

In one embodiment, the first RNTI is a non-negative integer.

In one embodiment, the first RNTI occupies 16 bits.

In one embodiment, the meaning of the first signaling being identified by a first RNTI comprises that a Cyclic Redundancy Check (CRC) included in the first signaling is scrambled by the first RNTI.

In one embodiment, the meaning of the first signaling being identified by a first RNTI comprises that the first signaling is scrambled by the first RNTI.

In one embodiment, the meaning of the first signaling being identified by a first RNTI comprises that the first signaling is generated by the first RNTI.

In one embodiment, the meaning of the first signaling being identified by a first RNTI comprises that the first RNTI is used to initialize a Generator of a Scrambling Sequence of the first signaling.

In one embodiment, the meaning of the first signaling being identified by a first RNTI comprises that the first RNTI is used to initialize a Generator of a Scrambling Sequence of a CRC included in the first signaling.

In one embodiment, the RNTI of the first type is an RNTI other than Cell Radio Network Temporary Identifier (C-RNTI).

In one embodiment, the RNTI of first type is used for scheduling other than dynamic scheduling.

In one embodiment, the first information block is transmitted via a physical layer signaling.

In one embodiment, the first information block is transmitted via Medium Access Control (MAC) Control Elements (CE).

In one embodiment, the first information block is transmitted via a PDCCH.

In one embodiment, the first information block is transmitted via a DCI.

In one embodiment, a CRC included in a PDCCH occupied by the first information block is scrambled via an RNTI other than the RNTI of first type.

In one embodiment, a CRC included in a PDCCH occupied by the first information block is scrambled via a C-RNTI.

In one embodiment, the first information block is dedicated to UE/UE-specific.

In one embodiment, the first information block is used to indicate a target time-frequency resource.

In one subembodiment of the embodiment, the target time-frequency resource comprises a Channel-State Information Reference Signal (CSI-RS) resource.

In one subembodiment of the embodiment, the target time-frequency resource comprises a Synchronization Signal/Physical Broadcast Channel block (SSB).

In one subembodiment of the embodiment, the target time-frequency resource comprises a Demodulation Reference Signal (DMRS) resource.

In one subembodiment of the embodiment, the target time-frequency resource comprises a Sounding Reference Signal (SRS) resource.

In one embodiment, the first information block is used to indicate a unified TCI.

Typically, the first information block is used to indicate a TCI.

Typically, the first information block is used to indicate a TCI-State.

Typically, the first information block is used to indicate a TCI-Stateld.

Typically, the first information block is used to indicate an SRS Resource Indicator (SRI).

Typically, the first information block being used to determine whether at least one CORESET is associated with a first identity or a second identity means that the first information block is used to indicate a first identifier, a reference signal associated with the first identifier and a demodulation reference signal in the CORESET being QCL, and the reference signal associated with the first identifier being associated with the first identity or the second identity.

Typically, the first information block being used to determine whether at least one CORESET is associated with a first identity or a second identity means that the first information block is used to indicate a first identifier, a reference signal associated with the first identifier and a PDCCH in the CORESET using identical QCL parameters, and the reference signal associated with the first identifier being associated with the first identity or the second identity.

In one embodiment, the reference signal comprises at least one of a CSI-RS or an SSB.

In one embodiment, the first identifier is used to determine one reference signal resource.

In one embodiment, the reference signal associated with the first identifier is associated with the first identity.

In one embodiment, the reference signal associated with the first identifier is associated with the second identity.

In one embodiment, the meaning of the phrase that the reference signal associated with the first identifier is associated with the first identity comprises: an RRC signaling configuring the reference signal associated with the first identifier including the first identity.

In one embodiment, the meaning of the phrase that the reference signal associated with the first identifier is associated with the first identity comprises: the reference signal associated with the first identifier being transmitted by a TRP corresponding to the first identity.

In one embodiment, the meaning of the phrase that the reference signal associated with the first identifier is associated with the first identity comprises: time-frequency resources occupied by the reference signal associated with the first identifier being maintained by a TRP corresponding to the first identity.

In one embodiment, the meaning of the phrase that the reference signal associated with the first identifier is associated with the first identity comprises: the reference signal associated with the first identifier being scrambled via the first identity.

In one embodiment, the meaning of the phrase that the reference signal associated with the first identifier is associated with the first identity comprises: the first identity being used to generate the reference signal associated with the first identifier.

In one embodiment, the meaning of the phrase that the reference signal associated with the first identifier is associated with the first identity comprises: there existing explicit signaling indicating that the time-frequency resources occupied by the reference signal associated with the first identifier and the first identity are correlated.

In one embodiment, the meaning of the phrase that the reference signal associated with the first identifier is associated with the second identity comprises: an RRC signaling configuring the reference signal associated with the first identifier including the second identity.

In one embodiment, the meaning of the phrase that the reference signal associated with the first identifier is associated with the second identity comprises: the reference signal associated with the first identifier being transmitted by a TRP corresponding to the second identity.

In one embodiment, the meaning of the phrase that the reference signal associated with the first identifier is associated with the second identity comprises: time-frequency resources occupied by the reference signal associated with the first identifier being maintained by a TRP corresponding to the second identity.

In one embodiment, the meaning of the phrase that the reference signal associated with the first identifier is associated with the second identity comprises: the reference signal associated with the first identifier being scrambled via the second identity.

In one embodiment, the meaning of the phrase that the reference signal associated with the first identifier is associated with the second identity comprises: the first identity being used to generate the reference signal associated with the second identifier.

In one embodiment, the meaning of the phrase that the reference signal associated with the first identifier is associated with the second identity comprises: there existing explicit signaling indicating that the time-frequency resources occupied by the reference signal associated with the first identifier and the second identity are correlated.

Typically, the first information block is used to determine whether the at least one CORESET is associated with the first identity or the second identity after first effective time.

In one embodiment, the meaning of the above sentence comprises that the first information block is used to indicate a first reference signal resource, the first reference signal resource being associated with the first identity or the second identity; the effective time of the first information block is the first effective time; there exists at least one CORESET in which a PDCCH transmitted uses a demodulation reference signal which is QCL with the first reference signal resource after the first effective time, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the effective time of the first information block is the first effective time; there exists at least one CORESET in which a PDCCH transmitted uses a demodulation reference signal which employs the same QCL parameters as the first reference signal resource after the first effective time, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the effective time of the first information block is the first effective time; there exists at least one CORESET being associated with a search space in which a PDCCH transmitted uses a demodulation reference signal which is QCL with the first reference signal resource after the first effective time, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the effective time of the first information block is the first effective time; there exists at least one CORESET being associated with a search space in which a PDCCH transmitted uses a demodulation reference signal which employs the same QCL parameters as the first reference signal resource after the first effective time, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the effective time of the first information block is the first effective time; there exists at least one CORESET being associated with a search space set in which a PDCCH transmitted uses a demodulation reference signal which is QCL with the first reference signal resource after the first effective time, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the effective time of the first information block is the first effective time; there exists at least one CORESET being associated with a search space set in which a PDCCH transmitted uses a demodulation reference signal which employs the same QCL parameters as the first reference signal resource after the first effective time, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the first information block is used to indicate that each demodulation reference signal used by the first node for all PDCCHs transmitted in user-specific CORESET after the first effective time is QCL with the first reference signal resource, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the first information block is used to indicate that each demodulation reference signal used by the first node for all PDCCHs transmitted in user-specific CORESET after the first effective time employs the same QCL parameters as the first reference signal resource, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the first information block is used to indicate that each demodulation reference signal used by the first node for all PDCCHs transmitted in CORESET configured by means of user-specific RRC signaling after the first effective time is QCL with the first reference signal resource, the first reference signal resource comprising at least one of a CSI-RS resource or an SSB.

In one embodiment, the meaning of the above sentence comprises that the first information block is used to indicate a first reference signal resource, the first reference signal resource being associated with the first identity or the second identity; the first information block is used to indicate that each demodulation reference signal used by the first node for all PDCCHs transmitted in CORESET configured by means of user-specific RRC signaling after the first effective time employs the same QCL parameters as the first reference signal resource, the first reference signal resource comprising at least one of a CSI-RS resource or an SSB.

Typically, the first information block is used to determine the first effective time.

In one embodiment, the phrase that the first information block is used to determine the first effective time means that the first node transmits a first feedback after receiving the first information block, the first feedback being an Acknowledgement of the first information block, and the first effective time being Y1 symbol(s) after a last symbol occupied by the first feedback, Y1 being a positive integer.

In one subembodiment of the embodiment, Y1 is configured by base station.

In one subembodiment of the embodiment, Y1 is fixed.

In one subembodiment of the embodiment, Y1 is related to a capability of the first node.

In one embodiment, the phrase that the first information block is used to determine the first effective time means that the first information block is used to indicate the first effective time.

In one embodiment, the phrase that the first information block is used to determine the first effective time means that the first effective time is X1 symbol(s) after a last symbol occupied by the first information block, X1 being a positive integer.

In one subembodiment of the embodiment, X1 is configured by base station.

In one subembodiment of the embodiment, X1 is fixed.

In one subembodiment of the embodiment, X1 is related to a capability of the first node.

In one embodiment, the first information block is used to determine whether a PDSCH scheduled by DCI in the at least one CORESET is associated with the first identity or the second identity after the first effective time.

In one subembodiment of the embodiment, the meaning of the above sentence comprises that the first information block is used to indicate a first reference signal resource, the first reference signal resource being associated with the first identity or the second identity; the effective time of the first information block is the first effective time; there exists at least one CORESET in which a PDSCH scheduled by DCI uses a demodulation reference signal which is QCL with the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; there exists at least one CORESET in which a PDSCH scheduled by DCI uses a demodulation reference signal which employs the same QCL parameters as the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; each demodulation reference signal used for all PDSCHs scheduled by DCI transmitted in UE-specific CORESET is QCL with the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; each demodulation reference signal used for all PDSCHs scheduled by DCI transmitted in UE-specific CORESET employs the same QCL parameters as the first reference signal resource after the first effective time, the first reference signal resource comprising at least one of a CSI-RS resource or an SSB.

In one embodiment, the first information block is used to determine whether a PUSCH scheduled by DCI in the at least one CORESET is associated with the first identity or the second identity after the first effective time.

In one subembodiment of the embodiment, the meaning of the above sentence comprises that the first information block is used to indicate a first reference signal resource, the first reference signal resource being associated with the first identity or the second identity; the effective time of the first information block is the first effective time; there exists at least one CORESET in which a PUSCH scheduled by DCI is QCL with the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; there exists at least one CORESET in which a PUSCH scheduled by DCI uses a spatial transmission parameter group that is QCL with the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; there exists at least one CORESET in which a PUSCH scheduled by DCI uses a spatial transmission parameter group that employs the same QCL parameters as the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; all PUSCHs scheduled by DCI transmitted in UE-specific CORESET are QCL with the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; all PUSCHs scheduled by DCI transmitted in UE-specific CORESET use a spatial transmission parameter group that is QCL with the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; all PUSCHs scheduled by DCI transmitted in UE-specific CORESET use a spatial transmission parameter group that employs the same QCL parameters as the first reference signal resource after the first effective time, the first reference signal resource comprising at least one of a CSI-RS resource or an SSB.

In one subembodiment of the embodiment, the meaning of the above sentence comprises that the first information block is used to indicate a first reference signal resource, the first reference signal resource being associated with the first identity or the second identity; the effective time of the first information block is the first effective time; all PUSCHs scheduled by DCI transmitted in UE-specific CORESET use a SRI that is associated with a TCI corresponding to the first reference signal resource after the first effective time, the first reference signal resource comprising at least one of a CSI-RS resource or an SSB.

In one embodiment, at least one of the first identity or the second identity is a physical cell identifier (PCI).

In one embodiment, the first identity is a PCI.

In one embodiment, the second identity is a PCI.

In one embodiment, the first identity is a PCI of Serving Cell.

In one embodiment, the second identity is different from a PCI of Serving Cell.

In one embodiment, the second identity is a PCI other than the PCI of Serving Cell.

In one embodiment, the first identity is one of ServCellIndex, Serv CellId or ServCellIdentity.

In one embodiment, the second identity is one of ServCellIndex, ServCellId or ServCellIdentity.

Typically, the meaning of determining whether to perform the scheduling activation indicated by the first signaling in at least first time-frequency resource set according to at least the first information block comprises: the first information block being used to determine a first effective time, the first effective time being used along with whether CORESET(s) determined by the first information block is(are) associated with the first identity to determine whether the scheduling activation indicated by the first signaling is performed in the at least first time-frequency resource set.

In one embodiment, the first time-frequency resource set is located before the first effective time, the scheduling activation indicated by the first signaling being performed in the first time-frequency resource set.

In one embodiment, the first time-frequency resource set is located after the first effective time, and CORESET(s) determined by the first information block is(are) associated with the first identity, the scheduling activation indicated by the first signaling being performed in the first time-frequency resource set.

In one embodiment, the first time-frequency resource set is located after the first effective time, and CORESET(s) determined by the first information block is(are) associated with the second identity, the scheduling activation indicated by the first signaling not being performed in the first time-frequency resource set.

In one embodiment, the first time-frequency resource set is located after the first effective time, and CORESET(s) determined by the first information block is(are) associated with the second identity, and CS or SPS to which the first time-frequency resource set belongs is deactivated.

In one embodiment, the first time-frequency resource set is located after the first effective time, and CORESET(s) determined by the first information block is(are) associated with the second identity, and CS or SPS to which the first time-frequency resource set belongs is released.

In one embodiment, the first operation comprises PDSCH receiving.

In one embodiment, the first operation comprises PUSCH transmitting.

In one embodiment, the first operation comprises PDCCH monitoring.

In one embodiment, the first operation comprises Physical Sidelink Shared Channel (PSSCH) receiving.

In one embodiment, the first operation comprises PSSCH transmitting.

In one embodiment, the RNTI of first type is used for activation or deactivation of semi-persistent scheduling.

In one embodiment, the RNTI of first type is used for activation or release of semi-persistent scheduling.

In one embodiment, the RNTI of first type is used for activation or deactivation of configured scheduling.

In one embodiment, the RNTI of first type is used for activation or release of configured scheduling. In one embodiment, the RNTI of first type is Configured Scheduling RNTI (CS-RNTI).

In one embodiment, the RNTI of first type is Semi-persistent Scheduling Radio Network Temporary Identifier (SPS-RNTI).

In one embodiment, the RNTI of first type is Semi-Persistent CSI RNTI (SP-CSI-RNTI).

In one embodiment, the RNTI of first type is SL Semi-Persistent Scheduling V-RNTI.

In one embodiment, the RNTI of first type is SideLink Configured Scheduling Radio Network Temporary Identifier (SL-CS-RNTI).

In one embodiment, the QCL parameters in the present application include at least one of QCL-TypeA, QCL-TypeB, QCL-TypeC or QCL-TypeD.

In one embodiment, the QCL relationship in the present application includes at least one of QCL-TypeA, QCL-TypeB, QCL-TypeC or QCL-TypeD.

In one embodiment, the QCL-TypeA comprises Doppler shift, Doppler spread, average delay and delay spread.

In one embodiment, the QCL-TypeB comprises Doppler shift and Doppler spread.

In one embodiment, the QCL-TypeC comprises Doppler shift and average delay.

In one embodiment, the QCL-TypeD comprises Spatial Rx parameter.

In one embodiment, the QCL parameters include at least one of a delay spread, a Doppler spread, a Doppler shift, an average delay, a Spatial Tx parameter or a Spatial Rx parameter.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NR-RAN 202, an Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 supports updating QCL relation with dynamic signaling.

In one embodiment, the UE 201 supports a unified TCI configuration.

In one embodiment, the UE 201 can receive CSI-RSs from multiple TRPs simultaneously.

In one embodiment, the UE 201 can receive SSBs from multiple TRPs simultaneously.

In one embodiment, the UE 201 is a terminal capable of monitoring multiple beams simultaneously.

In one embodiment, the UE 201 is a terminal supporting Massive-MIMO.

In one embodiment, the UE 201 supports non-dynamic scheduling.

In one embodiment, the UE201 supports DL SPS based transmission.

In one embodiment, the UE201 supports transmission of scheduling based on uplink configuration.

In one embodiment, the UE 201 supports transmission of configured scheduling in SL.

In one embodiment, the gNB203 corresponds to the second node in the present application.

In one embodiment, the gNB203 supports updating QCL relation with dynamic signaling.

In one embodiment, the gNB203 supports a unified TCI configuration.

In one embodiment, the gNB203 can receive CSI-RSs from multiple TRPs simultaneously.

In one embodiment, the gNB203 can receive SSBs from multiple TRPs simultaneously.

In one embodiment, the gNB203 is a base station capable of monitoring multiple beams simultaneously.

In one embodiment, the gNB203 is a base station supporting Massive-MIMO.

In one embodiment, the gNB203 supports non-dynamic scheduling.

In one embodiment, the gNB203 supports DL SPS based transmission.

In one embodiment, the gNB203 supports transmission of scheduling based on uplink configuration.

In one embodiment, the gNB203 supports transmission of configured scheduling in SL.

In one embodiment, the first node in the present application corresponds to the UE201, and the second node in the present application corresponds to the gNB203.

### Embodiment 3

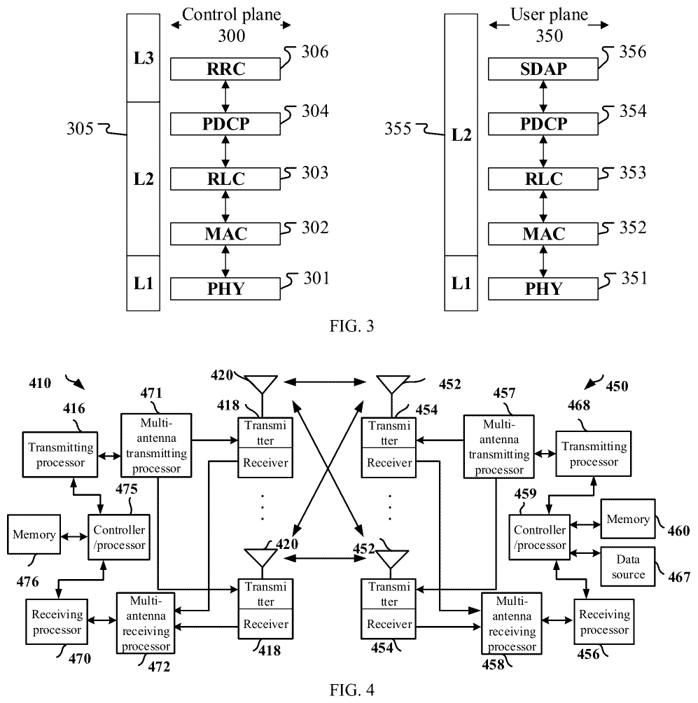

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The Radio Resource Control (RRC) sublayer 306 in the L3 is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP304 of the second communication node is used for generating scheduling of the first communication node.

In one embodiment, the PDCP354 of the second communication node is used for generating scheduling of the first communication node.

In one embodiment, the first signaling is generated by the MAC302 or the MAC352.

In one embodiment, the first signaling is generated by the PHY 301 or the PHY 351.

In one embodiment, the first information block is generated by the MAC302 or the MAC352.

In one embodiment, the first information block is generated by the PHY 301, or the PHY 351.

In one embodiment, the first message is generated by the MAC302 or the MAC352.

In one embodiment, the first message is generated by the RRC 306.

In one embodiment, the second information block is generated by the MAC302 or the MAC352.

In one embodiment, the second information block is generated by the PHY 301 or the PHY 351.

In one embodiment, the second signaling is generated by the MAC302 or the MAC352.

In one embodiment, the second signaling is generated by the PHY301 or the PHY351.

In one embodiment, the third signaling is generated by the MAC302 or the MAC352.

In one embodiment, the third signaling is generated by the PHY301 or the PHY351.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used for managing multiple TRPs.

In one embodiment, the second node is used for managing multiple nodes of cells.

In one embodiment, the second node is used for managing multiple nodes of carriers.

### Embodiment 4

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450—targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least firstly receives a first signaling, the first signaling indicating scheduling activation, the first signaling being identified by a first RNTI, the first RNTI being an RNTI of first type; and then receives a first information block, the first information block being generated at a protocol layer below RRC layer, the first information block being used to determine whether at least one CORESET is associated with a first identity or a second identity; and determines whether to perform the scheduling activation indicated by the first signaling in at least first time-frequency resource set according to at least the first information block; and performs a first operation in the at least first time-frequency resource set according to indication of the first signaling upon determination of performing the scheduling activation indicated by the first signaling in the at least first time-frequency resource set, or does not perform the first operation in the at least first time-frequency resource set upon determination of not performing the scheduling activation indicated by the first signaling in the at least first time-frequency resource set; each of the first identity and the second identity identifies one cell.

In one embodiment, the first communication device 450 comprises a memory that stores a computer readable instruction program. The computer readable instruction program generates actions when executed by at least one processor. The actions include: firstly receiving a first signaling, the first signaling indicating scheduling activation, the first signaling being identified by a first RNTI, the first RNTI being an RNTI of first type; and then receiving a first information block, the first information block being generated at a protocol layer below RRC layer, the first information block being used to determine whether at least one CORESET is associated with a first identity or a second identity; and determining whether to perform the scheduling activation indicated by the first signaling in at least first time-frequency resource set according to at least the first information block; and performing a first operation in the at least first time-frequency resource set according to indication of the first signaling upon determination of performing the scheduling activation indicated by the first signaling in the at least first time-frequency resource set, or not performing the first operation in the at least first time-frequency resource set upon determination of not performing the scheduling activation indicated by the first signaling in the at least first time-frequency resource set; each of the first identity and the second identity identifies one cell.

In one embodiment, the second communication device 410 comprises at least one processor and at least one memory. The at least one memory comprises computer program codes; the at least one memory and the computer program codes are configured to be used in collaboration with the at least one processor. The second communication device 410 at least firstly transmits a first signaling, the first signaling indicating scheduling activation, the first signaling being identified by a first RNTI, the first RNTI being an RNTI of first type; and then transmits a first information block, the first information block being generated at a protocol layer below RRC layer, the first information block being used to determine whether at least one CORESET is associated with a first identity or a second identity; and determines whether to perform the scheduling activation indicated by the first signaling in at least first time-frequency resource set according to at least the first information block; and performs a third operation in the at least first time-frequency resource set according to indication of the first signaling upon determination of performing the scheduling activation indicated by the first signaling in the at least first time-frequency resource set, or does not perform the third operation in the at least first time-frequency resource set upon determination of not performing the scheduling activation indicated by the first signaling in the at least first time-frequency resource set; each of the first identity and the second identity identifies one cell.

In one embodiment, the second communication device 410 comprises a memory that stores a computer readable instruction program. The computer readable instruction program generates actions when executed by at least one processor. The actions include: firstly transmitting a first signaling, the first signaling indicating scheduling activation, the first signaling being identified by a first RNTI, the first RNTI being an RNTI of first type; and then transmitting a first information block, the first information block being generated at a protocol layer below RRC layer, the first information block being used to determine whether at least one CORESET is associated with a first identity or a second identity; and determining whether to perform the scheduling activation indicated by the first signaling in at least first time-frequency resource set according to at least the first information block; and performing a third operation in the at least first time-frequency resource set according to indication of the first signaling upon determination of performing the scheduling activation indicated by the first signaling in the at least first time-frequency resource set, or not performing the third operation in the at least first time-frequency resource set upon determination of not performing the scheduling activation indicated by the first signaling in the at least first time-frequency resource set; each of the first identity and the second identity identifies one cell.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is network equipment.

In one embodiment, the second communication device 410 is a serving cell.

In one embodiment, the second communication device 410 is a TRP.

In one embodiment, at least the first four of the antenna 452, the receiver 454, the multi-antenna receiving processor 458, the receiving processor 456, and the controller/processor 459 are used for receiving a first signaling; at least the first four of the antenna 420, the transmitter 418, the multi-antenna transmitting processor 471, the transmitting processor 416 and the controller/processor 475 are used for transmitting a first signaling.

In one embodiment, at least the first four of the antenna 452, the receiver 454, the multi-antenna receiving processor 458, the receiving processor 456, and the controller/processor 459 are used for receiving a first information block; at least the first four of the antenna 420, the transmitter 418, the multi-antenna transmitting processor 471, the transmitting processor 416 and the controller/processor 475 are used for transmitting a first information block.

In one embodiment, at least the first four of the antenna 452, the receiver 454, the multi-antenna receiving processor 458, the receiving processor 456, and the controller/processor 459 are used to determine whether to perform the scheduling activation indicated by the first signaling in at least first time-frequency resource set according to at least the first information block; at least the first four of the antenna 420, the transmitter 418, the multi-antenna transmitting processor 471, the transmitting processor 416 and the controller/processor 475 are used to determine whether to perform the scheduling activation indicated by the first signaling in at least first time-frequency resource set according to at least the first information block.

In one embodiment, at least the first four of the antenna 452, the transmitter 454, the multi-antenna transmitting processor 457, the transmitting processor 468, and the controller/processor 459 are used to determine whether to perform the scheduling activation indicated by the first signaling in at least first time-frequency resource set according to at least the first information block; at least the first four of the antenna 420, the receiver 418, the multi-antenna receiving processor 472, the receiving processor 470 and the controller/processor 475 are used to determine whether to perform the scheduling activation indicated by the first signaling in at least first time-frequency resource set according to at least the first information block.

In one embodiment, at least the first four of the antenna 452, the receiver 454, the multi-antenna receiving processor 458, the receiving processor 456, and the controller/processor 459 are used to receive a first message; at least the first four of the antenna 420, the transmitter 418, the multi-antenna transmitting processor 471, the transmitting processor 416 and the controller/processor 475 are used to transmit a first message.

In one embodiment, at least the first four of the antenna 452, the receiver 454, the multi-antenna receiving processor 458, the receiving processor 456, and the controller/processor 459 are used for receiving a second information block; at least the first four of the antenna 420, the transmitter 418, the multi-antenna transmitting processor 471, the transmitting processor 416 and the controller/processor 475 are used for transmitting a second information block.

In one embodiment, at least the first four of the antenna 452, the transmitter 454, the multi-antenna transmitting processor 457, the transmitting processor 468 and the controller/processor 459 are used to transmit a third signaling; at least the first four of the antenna 420, the receiver 418, the multi-antenna receiving processor 472, the receiving processor 470 and the controller/processor 475 are used to receive a third signaling.

### Embodiment 5

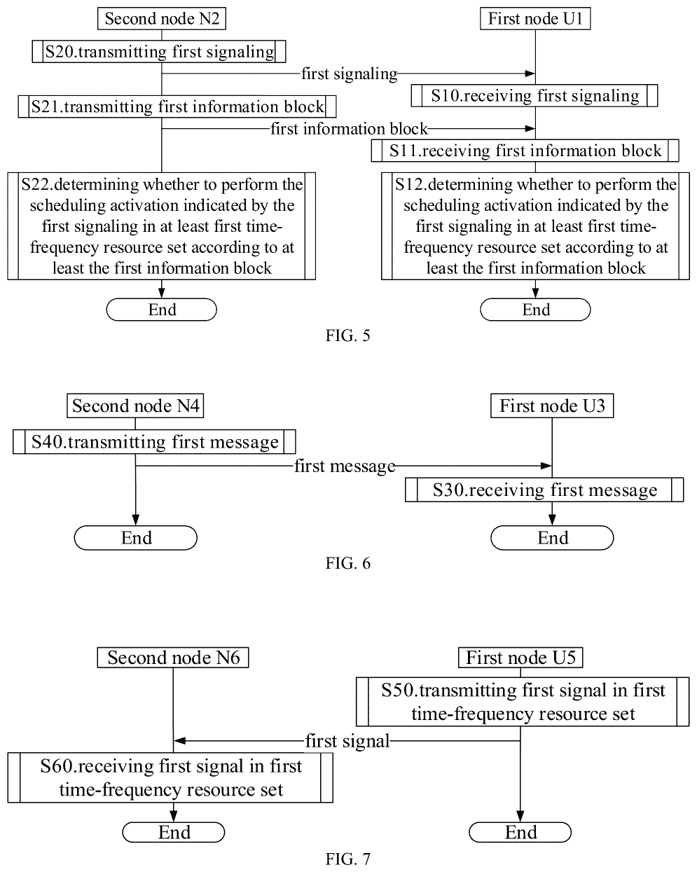

Embodiment 5 illustrates a flowchart of a first signaling, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 5 can be applied to any of Embodiments 6 through 14; conversely, in case of no conflict, the embodiments, sub-embodiments, and subsidiary embodiments in any of Embodiments 6 through 14 can be applied to Embodiment 5.

The first node U1 receives a first signaling in step S10; and receives a first information block in step S11; and determines in step S12 whether to perform the scheduling activation indicated by the first signaling in at least first time-frequency resource set according to at least the first information block.

The second node N2 transmits a first signaling in step S20; and transmits a first information block in step S21; and determines in step S22 whether to perform the scheduling activation indicated by the first signaling in at least first time-frequency resource set according to at least the first information block.

In Embodiment 5, the first signaling indicates scheduling activation, and the first signaling is identified by a first RNTI, the first RNTI being an RNTI of first type; the first information block is generated at a protocol layer below RRC layer, the first information block being used to determine whether at least one CORESET is associated with a first identity or a second identity; upon determination of performing the scheduling activation indicated by the first signaling in the at least first time-frequency resource set, the first node performs a first operation in the at least first time-frequency resource set according to indication of the first signaling, and the second node performs a third operation in the at least first time-frequency resource set according to indication of the first signaling; upon determination of not performing the scheduling activation indicated by the first signaling in the at least first time-frequency resource set, the first node does not perform the first operation in the at least first time-frequency resource set, and the second node does not perform the third operation in the at least first time-frequency resource set; each of the first identity and the second identity identifies one cell.

In one embodiment, the phrase “receives a first information block in step S11” comprises receiving the second signaling.

In one embodiment, the phrase “transmits a first information block in step S21” comprises transmitting the second signaling.

In one embodiment, a second signaling comprises the first information block, and the second signaling also comprises a first field; the first field of the second signaling is used to indicate a HARQ process number used by a radio signal scheduled by the second signaling, or the first field of the second signaling is used to indicate an RV used by a radio signal scheduled by the second signaling; and the first field is not used to suspend or deactivate a PDCCH Validation.

In one embodiment, a physical layer channel occupied by the second signaling includes a PDCCH.

In one embodiment, the second signaling is a DCI.

In one embodiment, the second signaling is a UL Grant.

In one embodiment, the second signaling is a DL Grant.

In one embodiment, the second signaling is not used for DL SPS Release.

In one embodiment, the second signaling is not used for UL Grant Type2 Scheduling Release.

In one embodiment, the second signaling is not used for SL Configured Grant Type2 Scheduling Release.

### Embodiment 6

Embodiment 6 illustrates a flowchart of a first message, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 6 can be applied to any of Embodiments 5 through 14; conversely, in case of no conflict, the embodiments, sub-embodiments, and subsidiary embodiments in any of Embodiments 5 through 14 can be applied to Embodiment 6.

The first node U3 receives a first message in step S30.

The second node N4 transmits a first message in step S40.

In Embodiment 6, the first message is used to configure at least one RNTI; the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.

Typically, the at least one RNTI includes the RNTI of first type.

In one embodiment, the first message is an RRC signaling.

In one embodiment, the first message comprises the first RNTI.

In one embodiment, the first message is used to configure a PCI cell.

In one embodiment, the first message is used to configure a cell other than a serving cell.

In one embodiment, a name of an RRC signaling carrying the first message includes PCI.

In one embodiment, a name of an RRC signaling carrying the first message includes Cell.

In one embodiment, a name of an RRC signaling carrying the first message includes Non.

In one embodiment, a name of an RRC signaling carrying the first message includes Serving.

In one embodiment, the first time-frequency resource set is located after the first effective time; when the first message includes a second RNTI and the second RNTI is an RNTI of the first type, the first node performs the scheduling activation indicated by the first signaling in the at least first time-frequency resource set; when the first message does not include a second RNTI, the first node does not perform the scheduling activation indicated by the first signaling in the at least first time-frequency resource set.

In one subembodiment of the embodiment, the second RNTI is different from the first RNTI.

In one subembodiment of the embodiment, the second RNTI and the first RNTI are both RNTIs of the first type.

In one subembodiment of the embodiment, the first node deactivates a CS or SPS associated with the first time-frequency resource set when the first message does not include the second RNTI.

In one subembodiment of the embodiment, the first node releases a CS or SPS associated with the first time-frequency resource set when the first message does not include the second RNTI.

In one embodiment, when the first message includes a second RNTI, the first RNTI is associated with the first identity and the second RNTI is associated with the second identity.

In one subembodiment of the embodiment, when the first identity is used by the first node to generate a radio signal to be transmitted or received, the first RNTI is also used by the first node to generate a radio signal to be transmitted or received.

In one subembodiment of the embodiment, when the second identity is used by the first node to generate a radio signal to be transmitted or received, the second RNTI is also used by the first node to generate a radio signal to be transmitted or received.

In one embodiment, the first message comprises a third RNTI and a fourth RNTI, the third RNTI and the fourth RNTI both being RNTIs other than the RNTIs of the first type.

In one subembodiment of the embodiment, the third RNTI is a C-RNTI.

In one subembodiment of the embodiment, the fourth RNTI is a C-RNTI.

In one subembodiment of the embodiment, the third RNTI is associated with the first identity and the fourth RNTI is associated with the second identity.

In one subembodiment of the embodiment, when the first identity is used by the first node to generate a radio signal to be transmitted or received, the third RNTI is also used by the first node to generate a radio signal to be transmitted or received.

In one subembodiment of the embodiment, when the second identity is used by the first node to generate a radio signal to be transmitted or received, the fourth RNTI is also used by the first node to generate a radio signal to be transmitted or received

In one embodiment, the step S30 is located before the step S10 in Embodiment 5.

In one embodiment, the step S40 is located before the step S20 in Embodiment 5.

### Embodiment 7

Embodiment 7 illustrates a flowchart of performing a first operation, as shown in FIG. 7. In FIG. 7, a first node U5 and a second node N6 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 7 can be applied to any of Embodiments 5 through 14; conversely, in case of no conflict, the embodiments, sub-embodiments, and subsidiary embodiments in any of Embodiments 5 through 14 can be applied to Embodiment 7.

The first node U5 transmits a first signal in a first time-frequency resource set in step S50.

The second node N6 receives a first signal in a first time-frequency resource set in step S60.

In Embodiment 7, both the first node and the second node determine to perform the scheduling activation indicated by the first signaling in the at least first time-frequency resource set, the first operation performed by the first node comprising transmitting the first signal, and the third operation performed by the second node comprising receiving the first signal.

In one embodiment, a physical layer channel occupied by the first signal includes a PUSCH.

In one embodiment, a physical layer channel occupied by the first signal includes a PSSCH.

In one embodiment, the first signal comprises Uplink Control Information (UCI).

In one embodiment, the first signal comprises Channel State Information (CSI).

In one embodiment, the first signal is an Uplink (UL) Grant.

In one embodiment, the first signal is a Configured UL Grant.

In one embodiment, the first signal is a baseband signal.

In one embodiment, the first signal is a radio signal.

In one embodiment, the first signaling is used to indicate frequency-domain resources occupied by the first time-frequency resource set.

In one embodiment, the first signaling is used to indicate an MCS used by the first signal.

In one embodiment, the step S50 is located after the step S12 in Embodiment 5.

In one embodiment, the step S60 is located after the step S22 in Embodiment 5.

### Embodiment 8

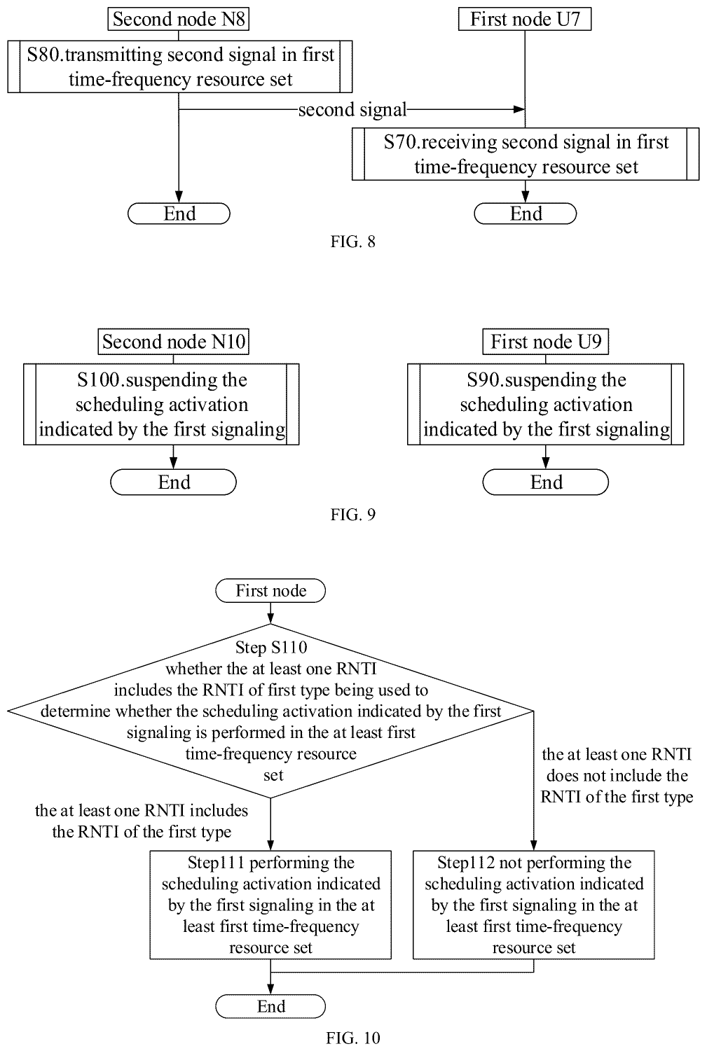

Embodiment 8 illustrates another flowchart of performing a first operation, as shown in FIG. 8. In FIG. 8, a first node U7 and a second node N8 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 8 can be applied to any of Embodiments 5 through 14; conversely, in case of no conflict, the embodiments, sub-embodiments, and subsidiary embodiments in any of Embodiments 5 through 14 can be applied to Embodiment 8.

The first node U7 receives a second signal in a first time-frequency resource set in step S70.

The second node N8 transmits a second signal in a first time-frequency resource set in step S80.

In Embodiment 8, both the first node and the second node determine to perform the scheduling activation indicated by the first signaling in the at least first time-frequency resource set, the first operation performed by the first node comprising receiving the second signal, and the third operation performed by the second node comprising transmitting the second signal.

In one embodiment, a physical layer channel occupied by the second signal includes a PDSCH.

In one embodiment, a physical layer channel occupied by the second signal includes a PDCCH.

In one embodiment, a physical layer channel occupied by the second signal includes a PSSCH.

In one embodiment, the second signal is a Downlink Assignment.

In one embodiment, the second signal is a baseband signal.

In one embodiment, the second signal is a radio signal.

In one embodiment, the first signaling is used to indicate frequency-domain resources occupied by the first time-frequency resource set.

In one embodiment, the first signaling is used to indicate an MCS used by the second signal.

In one embodiment, the step S70 is located after the step S12 in Embodiment 5.

In one embodiment, the step S80 is located after the step S22 in Embodiment 5.

### Embodiment 9

Embodiment 9 illustrates a flowchart of not performing a first operation, as shown in FIG. 9. In FIG. 9, a first node U9 and a second node N10 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 9 can be applied to any of Embodiments 5 through 14; conversely, in case of no conflict, the embodiments, sub-embodiments, and subsidiary embodiments in any of Embodiments 5 through 14 can be applied to Embodiment 9.

The first node U9 suspends the scheduling activation indicated by the first signaling in step S90.

The second node N10 suspends the scheduling activation indicated by the first signaling in step S100.

In one embodiment, the suspending the scheduling activation indicated by the first signaling comprises: deactivating an SPS or CS process associated with the first signaling.

In one embodiment, the suspending the scheduling activation indicated by the first signaling comprises:

releasing an SPS or CS process associated with the first signaling.

In one embodiment, the suspending the scheduling activation indicated by the first signaling comprises: pausing in an SPS or CS process associated with the first signaling.

In one embodiment, the step S90 is located after the step S12 in Embodiment 5.

In one embodiment, the step S100 is located after the step S22 in Embodiment 5.

### Embodiment 10

Embodiment 10 illustrates a flowchart of determining whether to perform the scheduling activation indicated by the first signaling, as shown in FIG. 10. In case of no conflict, the embodiments, sub-embodiments, and subsidiary embodiments in Embodiment 10 can be applied to any of Embodiments 5 through 14; conversely, in case of no conflict, the embodiments, sub-embodiments, and subsidiary embodiments in any of Embodiments 5 through 14 can be applied to Embodiment 10.

For the first node U11.
in step S110, whether the at least one RNTI includes the RNTI of first type is used to determine whether the scheduling activation indicated by the first signaling is performed in the at least first time-frequency resource set;
when the at least one RNTI includes the RNTI of the first type, proceeding to step 111, i.e. performing the scheduling activation indicated by the first signaling in the at least first time-frequency resource set;
when the at least one RNTI does not include the RNTI of the first type, proceeding to step 112, i.e. not performing the scheduling activation indicated by the first signaling in the at least first time-frequency resource set.

In Embodiment 10, the first message is used to configure at least one RNTI; the first information block is used to determine that the at least one CORESET is associated with the second identity, and the first information block is used to determine that the at least one RNTI is applied in the at least one CORESET.

Typically, the at least one RNTI includes the RNTI of first type.

In one embodiment, the first message is an RRC signaling.

In one embodiment, the first message comprises the first RNTI.

In one embodiment, the first message is used to configure a PCI cell.

In one embodiment, the first message is used to configure a cell other than a serving cell.

In one embodiment, a name of an RRC signaling carrying the first message includes PCI.

In one embodiment, a name of an RRC signaling carrying the first message includes Cell.

In one embodiment, a name of an RRC signaling carrying the first message includes Non.

In one embodiment, a name of an RRC signaling carrying the first message includes Serving.

In one embodiment, the first time-frequency resource set is located after the first effective time; when the first message includes a second RNTI and the second RNTI is an RNTI of the first type, the first node performs the scheduling activation indicated by the first signaling in the at least first time-frequency resource set; when the first message does not include a second RNTI, the first node does not perform the scheduling activation indicated by the first signaling in the at least first time-frequency resource set.

In one subembodiment of the embodiment, the second RNTI is different from the first RNTI.

In one subembodiment of the embodiment, the second RNTI and the first RNTI are both RNTIs of the first type.

In one subembodiment of the embodiment, the first node deactivates a CS or SPS associated with the first time-frequency resource set when the first message does not include the second RNTI.

In one subembodiment of the embodiment, the first node releases a CS or SPS associated with the first time-frequency resource set when the first message does not include the second RNTI.

In one embodiment, when the first message includes a second RNTI, the first RNTI is associated with the first identity and the second RNTI is associated with the second identity.

In one subembodiment of the embodiment, when the first identity is used by the first node to generate a radio signal to be transmitted or received, the first RNTI is also used by the first node to generate a radio signal to be transmitted or received.

In one subembodiment of the embodiment, when the second identity is used by the first node to generate a radio signal to be transmitted or received, the second RNTI is also used by the first node to generate a radio signal to be transmitted or received.

In one embodiment, the first message comprises a third RNTI and a fourth RNTI, the third RNTI and the fourth RNTI both being RNTIs other than the RNTIs of the first type.

In one subembodiment of the embodiment, the third RNTI is a C-RNTI.

In one subembodiment of the embodiment, the fourth RNTI is a C-RNTI.

In one subembodiment of the embodiment, the third RNTI is associated with the first identity and the fourth RNTI is associated with the second identity.

In one subembodiment of the embodiment, when the first identity is used by the first node to generate a radio signal to be transmitted or received, the third RNTI is also used by the first node to generate a radio signal to be transmitted or received.

In one subembodiment of the embodiment, when the second identity is used by the first node to generate a radio signal to be transmitted or received, the fourth RNTI is also used by the first node to generate a radio signal to be transmitted or received.

### Embodiment 11

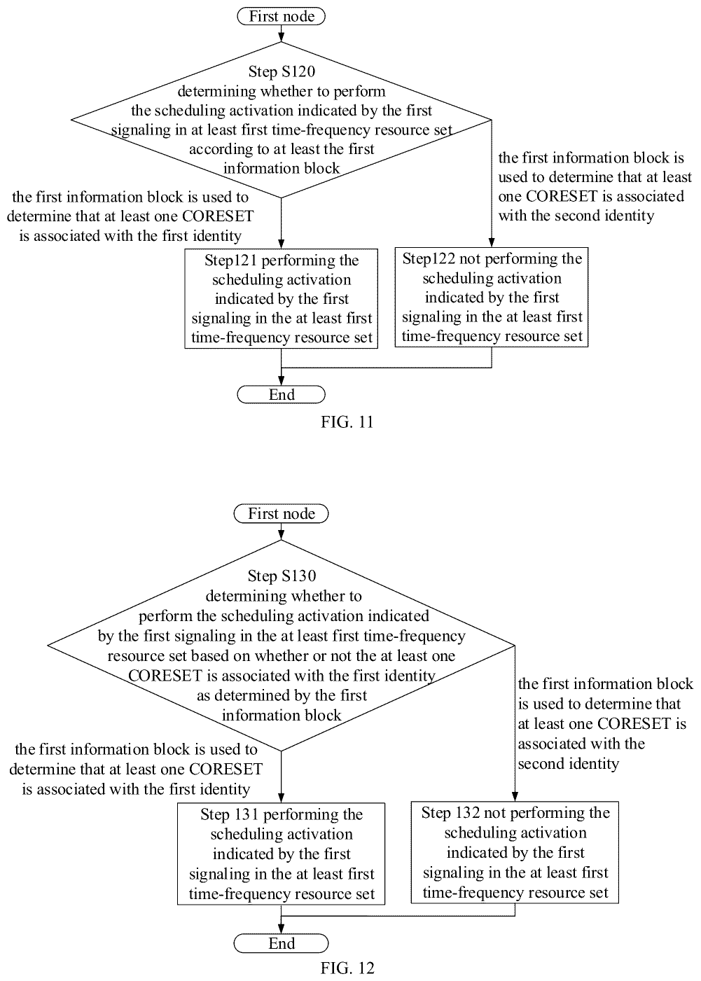

Embodiment 11 illustrates another flowchart of determining whether to perform the scheduling activation indicated by the first signaling, as shown in FIG. 11. In case of no conflict, the embodiments, sub-embodiments, and subsidiary embodiments in Embodiment 11 can be applied to any of Embodiments 5 through 14; conversely, in case of no conflict, the embodiments, sub-embodiments, and subsidiary embodiments in any of Embodiments 5 through 14 can be applied to Embodiment 11.

For the first node U12,
determining in step S120 whether to perform the scheduling activation indicated by the first signaling in at least first time-frequency resource set according to at least the first information block;
when the first information block is used to determine that at least one CORESET is associated with the first identity, proceeding to step 121, i.e. performing the scheduling activation indicated by the first signaling in the at least first time-frequency resource set;
when the first information block is used to determine that at least one CORESET is associated with the second identity; proceeding to step 122, i.e. not performing the scheduling activation indicated by the first signaling in the at least first time-frequency resource set.

In Embodiment 11, the at least one RNTI does not include the RNTI of first type.

In one embodiment, the scheduling activation indicated by the first signaling is performed when the at least one RNTI does not include the RNTI of first type and the first information block is used to determine that at least one CORESET is associated with the first identity; the scheduling activation indicated by the first signaling is not performed when the at least one RNTI does not include the RNTI of first type and the first information block is used to determine that at least one CORESET is associated with the second identity.

In one embodiment, the scheduling activation indicated by the first signaling is performed when the at least one RNTI does not include the RNTI of first type and the first information block is used to determine that at least one CORESET is associated with the first identity; the scheduling activation indicated by the first signaling is released when the at least one RNTI does not include the RNTI of first type and the first information block is used to determine that at least one CORESET is associated with the second identity.

In one embodiment, the scheduling activation indicated by the first signaling is performed when the at least one RNTI does not include the RNTI of first type and the first information block is used to determine that at least one CORESET is associated with the first identity; the scheduling activation indicated by the first signaling is deactivated when the at least one RNTI does not include the RNTI of first type and the first information block is used to determine that at least one CORESET is associated with the second identity.

### Embodiment 12

Embodiment 12 illustrates a third flowchart of determining whether to perform the scheduling activation indicated by the first signaling, as shown in FIG. 12. In case of no conflict, the embodiments, sub-embodiments, and subsidiary embodiments in Embodiment 12 can be applied to any of Embodiments 5 through 14; conversely; in case of no conflict, the embodiments, sub-embodiments, and subsidiary embodiments in any of Embodiments 5 through 14 can be applied to Embodiment 12.

For the first node U13,
determining in step S130 whether to perform the scheduling activation indicated by the first signaling in the at least first time-frequency resource set based on whether or not the at least one CORESET is associated with the first identity as determined by the first information block;
when the first information block is used to determine that at least one CORESET is associated with the first identity, proceeding to step 131, i.e. performing the scheduling activation indicated by the first signaling in the at least first time-frequency resource set;
when the first information block is used to determine that at least one CORESET is associated with the second identity, proceeding to step 132, i.e. not performing the scheduling activation indicated by the first signaling in the at least first time-frequency resource set.

### Embodiment 13

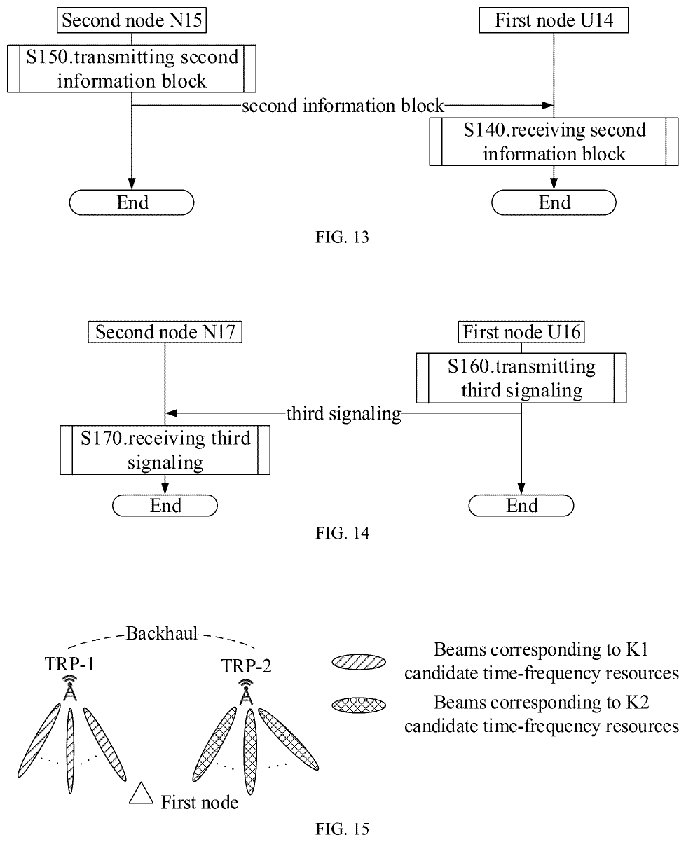

Embodiment 13 illustrates a flowchart of a second information block, as shown in FIG. 13. In FIG. 13, a first node U14 and a second node N15 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 13 can be applied to any of Embodiments 5 through 14; conversely, in case of no conflict, the embodiments, sub-embodiments, and subsidiary embodiments in any of Embodiments 5 through 14 can be applied to Embodiment 13.

The first node U14 receives a second information block in step S140.

The second node N15 transmits a second information block in step S150.

In Embodiment 13, time-domain resources occupied by the second information block are located after the first information block; the second information block is generated at a protocol layer below RRC layer, the second information block being used to determine that at least one CORESET is associated with the first identity; the first information block is used to determine that at least one CORESET is associated with the second identity, and at least the first information block is used to determine that the scheduling activation indicated by the first signaling is not performed in the at least first time-frequency resource set; the second information block is used to determine that the scheduling activation indicated by the first signaling is performed after a second effective time, and the second information block is used to determine the second effective time.

In one embodiment, the second information block is transmitted via a physical layer signaling.

In one embodiment, the second information block is transmitted via Medium Access Control (MAC) Control Elements (CE).

In one embodiment, the second information block is transmitted via a PDCCH.

In one embodiment, the second information block is transmitted via a DCI.

In one embodiment, a CRC included in a PDCCH occupied by the second information block is scrambled via an RNTI other than the RNTI of first type.

In one embodiment, a CRC included in a PDCCH occupied by the second information block is scrambled via a C-RNTI.

In one embodiment, the second information block is dedicated to UE/UE-specific.

In one embodiment, the second information block is used to indicate a candidate time-frequency resource.

In one subembodiment of the embodiment, the candidate time-frequency resource comprises a CSI-RS resource.

In one subembodiment of the embodiment, the candidate time-frequency resource comprises an SSB.

In one subembodiment of the embodiment, the candidate time-frequency resource comprises a DMRS resource.

In one subembodiment of the embodiment, the candidate time-frequency resource comprises an SRS resource.

In one embodiment, the second information block is used to indicate a Unified TCI.

Typically, the second information block is used to indicate a TCI.

Typically, the second information block is used to indicate a TCI-State.

Typically, the second information block is used to indicate a TCI-Stateld.

Typically, the second information block is used to indicate an SRI.

Typically, the phrase the second information block being used to determine that at least one CORESET is associated with a first identity means that the second information block is used to indicate a second identifier, a reference signal associated with the second identifier and a demodulation reference signal in the CORESET being QCL, and the reference signal associated with the second identifier being associated with the first identity.

Typically, the phrase the second information block being used to determine that at least one CORESET is associated with a first identity means that the second information block is used to indicate a second identifier, a reference signal associated with the second identifier and a PDCCH in the CORESET using identical QCL parameters, and the reference signal associated with the second identifier being associated with the first identity.

In one embodiment, the reference signal comprises at least one of a CSI-RS or an SSB.

In one embodiment, the second identifier is used to determine one reference signal resource.

In one embodiment, the reference signal associated with the second identifier is associated with the first identity.

In one embodiment, the meaning of the phrase that the reference signal associated with the second identifier is associated with the first identity comprises: an RRC signaling configuring the reference signal associated with the second identifier including the first identity.

In one embodiment, the meaning of the phrase that the reference signal associated with the second identifier is associated with the first identity comprises: the reference signal associated with the second identifier being transmitted by a TRP corresponding to the first identity.

In one embodiment, the meaning of the phrase that the reference signal associated with the second identifier is associated with the first identity comprises: time-frequency resources occupied by the reference signal associated with the second identifier being maintained by a TRP corresponding to the first identity.

In one embodiment, the meaning of the phrase that the reference signal associated with the second identifier is associated with the first identity comprises: the reference signal associated with the second identifier being scrambled via the first identity.

In one embodiment, the meaning of the phrase that the reference signal associated with the second identifier is associated with the first identity comprises: the first identity being used to generate the reference signal associated with the second identifier.

In one embodiment, the meaning of the phrase that the reference signal associated with the second identifier is associated with the first identity comprises: there existing explicit signaling indicating that the time-frequency resources occupied by the reference signal associated with the second identifier and the first identity are correlated.

In one embodiment, the phrase that the second information block is used to determine the second effective time means that the first node transmits a second feedback after receiving the second information block, the second feedback being an Acknowledgement of the second information block, and the second effective time being Y2 symbol(s) after a last symbol occupied by the second feedback, Y2 being a positive integer.

In one subembodiment of the embodiment, Y2 is configured by base station.

In one subembodiment of the embodiment, Y2 is fixed.

In one subembodiment of the embodiment, Y2 is related to a capability of the first node.

In one embodiment, the phrase that the second information block is used to determine the second effective time means that the second information block is used to indicate the second effective time.

In one embodiment, the phrase that the second information block is used to determine the second effective time means that the second effective time is X2 symbol(s) after a last symbol occupied by the second information block, X2 being a positive integer.

In one subembodiment of the embodiment, X2 is configured by base station.

In one subembodiment of the embodiment, X2 is fixed.

In one subembodiment of the embodiment, X2 is related to a capability of the first node.

In one embodiment, the phrase performing the scheduling activation indicated by the first signaling comprises: resuming the scheduling as indicated by the first signaling.

In one embodiment, the phrase performing the scheduling activation indicated by the first signaling comprises: performing a second operation in at least second time-frequency resource set as indicated by the first signaling.

In one subembodiment of the embodiment, the second time-frequency resource set occupies a positive integer number (more than one) of REs.

In one subembodiment of the embodiment, the second time-frequency resource set is located after the second effective time.

In one subembodiment of the embodiment, the second operation comprises PDSCH receiving.

In one subembodiment of the embodiment, the second operation comprises PUSCH transmitting.

In one subembodiment of the embodiment, the second operation comprises PDCCH monitoring.

In one subembodiment of the embodiment, the second operation comprises PSSCH receiving.

In one subembodiment of the embodiment, the second operation comprises PSSCH transmitting.

In one subembodiment of the embodiment, the first time-frequency resource set and the second time-frequency resource set belong to a same sps-ConfigIndex.

In one subembodiment of the embodiment, the first time-frequency resource set and the second time-frequency resource set belong to a same configuredGrantConfigIndex.

In one subembodiment of the embodiment, the first time-frequency resource set and the second time-frequency resource set belong to a same configuredGrantConfigIndexMAC.

In one subembodiment of the embodiment, the first time-frequency resource set and the second time-frequency resource set belong to a same sl-ConfigIndexCG.

In one subembodiment of the embodiment, the radio signal transmitted in the second time-frequency resource set is QCL with the reference signal transmitted in the candidate time-frequency resource.

In one subembodiment of the embodiment, the radio signal transmitted in the second time-frequency resource set uses the same QCL parameters as the reference signal transmitted in the candidate time-frequency resource.

In one embodiment, the step S140 is located after the step S12 in Embodiment 5.

In one embodiment, the step S150 is located after the step S22 in Embodiment 5.

### Embodiment 14

Embodiment 14 illustrates a flowchart of a third signaling, as shown in FIG. 14. In FIG. 14, a first node U16 and a second node N17 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 14 can be applied to any of Embodiments 5 through 13; conversely, in case of no conflict, the embodiments, sub-embodiments, and subsidiary embodiments in any of Embodiments 5 through 13 can be applied to Embodiment 14.

The first node U16 transmits a third signaling in step S160.

The second node N17 receives a third signaling in step S170.

In Embodiment 14, the third signaling is used to determine the first information block, the first information block being used to determine a first effective time, a position of the first effective time in time domain relating to time-domain resources occupied by the third signaling.

In one embodiment, the first effective time is Y3 symbol(s) after a last symbol occupied by the third signaling, Y3 being a positive integer.

In one subembodiment of the embodiment, Y3 is configured by base station.

In one subembodiment of the embodiment, Y3 is fixed.

In one subembodiment of the embodiment, Y3 is related to a capability of the first node.

In one embodiment, the first effective time is Y4 slot(s) after slots occupied by the third signaling, Y4 being a positive integer.

In one subembodiment of the embodiment, Y4 is configured by base station.

In one subembodiment of the embodiment, Y4 is fixed.

In one subembodiment of the embodiment, Y4 is related to a capability of the first node.

In one embodiment, the step S160 is after the step S11 and before the step S12 in Embodiment 5.

In one embodiment, the step S170 is after the step S21 and before the step S22 in Embodiment 5.

### Embodiment 15

Embodiment 15 illustrates a schematic of an application scenario, as shown in FIG. 15. In FIG. 15, both TRP-1 and TRP-2 shown are managed by the second node in this application; or the TRP-1 shown is managed by the second node in this application and the TRP-2 is managed by a neighboring base station of the second node; the first identity in this application is associated with the TRP-1 and the second identity in this application is associated with the TRP-2; the first node moves within the coverage of the TRP-1 as well as the coverage of the TRP-2.

TRP-1 shown in the figure maintains a first candidate time-frequency resource set, the first candidate time-frequency resource set comprising K1 candidate time-frequency resources; and TRP-2 shown in the figure maintains a second candidate time-frequency resource set, the second candidate time-frequency resource set comprising K2 candidate time-frequency resources.
the first information block is used to indicate a target time-frequency resource, the target time-frequency resource being one of the K1 candidate time-frequency resources, or the target time-frequency resource being one of the K2 candidate time-frequency resources; both K1 and K2 are positive integers greater than 1.

In one embodiment, the K1 candidate time-frequency resources respectively correspond to K1 TCI-StateIds.

In one embodiment, the K1 candidate time-frequency resources are associated with the first identity.

In one embodiment, the K2 candidate time-frequency resources respectively correspond to K2 TCI-StateIds.

In one embodiment, the K2 candidate time-frequency resources are associated with the second identity. In one embodiment, between the TRP-1 and the TRP-2 there exists a Backhaul Link.

In one embodiment, the second information block is used to indicate a candidate time-frequency resource, the candidate time-frequency resource being one of the K1 candidate time-frequency resources, or the candidate time-frequency resource being one of the K2 candidate time-frequency resources.

In one embodiment, the first information block is used to indicate a target time-frequency resource, the target time-frequency resource being one of the K2 candidate time-frequency resources, or the target time-frequency resource being one of the K1 candidate time-frequency resources.

### Embodiment 16

Embodiment 16 illustrates a structure block diagram of a processing device in a first node, as shown in FIG. 16. In FIG. 16, a first node 1600 comprises a first receiver 1601 and a first transceiver 1602.

The first receiver 1601 receives a first signaling, the first signaling indicating scheduling activation, the first signaling being identified by a first RNTI, the first RNTI being an RNTI of first type; and receiving a first information block, the first information block being generated at a protocol layer below RRC layer, the first information block being used to determine whether at least one CORESET is associated with a first identity or a second identity;
the first transceiver 1602 determines whether to perform the scheduling activation indicated by the first signaling in at least first time-frequency resource set according to at least the first information block; performs a first operation in the at least first time-frequency resource set according to indication of the first signaling upon determination of performing the scheduling activation indicated by the first signaling in the at least first time-frequency resource set, or does not perform the first operation in the at least first time-frequency resource set upon determination of not performing the scheduling activation indicated by the first signaling in the at least first time-frequency resource set.

In Embodiment 16, each of the first identity and the second identity identifies one cell.

In one embodiment, the first receiver 1601 receives a first message, the first message being used to configure at least one RNTI; the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.

In one embodiment, when the at least one RNTI includes/include the RNTI of first type, it is determined that the scheduling activation indicated by the first signaling is performed in the at least first time-frequency resource set; when the at least one RNTI does/do not include the RNTI of first type, whether to perform the scheduling activation indicated by the first signaling in the at least first time-frequency resource set is determined according to at least the first information block.

In one embodiment, when the first information block is used to determine that the at least one CORESET is associated with the first identity, it is determined that the scheduling activation indicated by the first signaling is performed in the at least first time-frequency resource set; when the first information block is used to determine that the at least one CORESET is associated with the second identity, it is determined that the scheduling activation indicated by the first signaling is not performed in the at least first time-frequency resource set.

In one embodiment, the first transceiver 1602 receives a second information block after the first information block, the second information block being generated at a protocol layer below RRC layer, the second information block being used to determine that at least one CORESET is associated with the first identity; the first information block is used to determine that at least one CORESET is associated with the second identity, and at least the first information block is used to determine that the scheduling activation indicated by the first signaling is not performed in the at least first time-frequency resource set; the second information block is used to determine that the scheduling activation indicated by the first signaling is performed after a second effective time, and the second information block is used to determine the second effective time.

In one embodiment, a second signaling comprises the first information block, and the second signaling also comprises a first field; the first field of the second signaling is used to indicate a HARQ process number used by a radio signal scheduled by the second signaling, or the first field of the second signaling is used to indicate an RV used by a radio signal scheduled by the second signaling; and the first field is not used to suspend or deactivate a PDCCH Validation.

In one embodiment, the first transceiver 1602 transmits a third signaling, the third signaling being used to determine the first information block, the first information block being used to determine a first effective time, a position of the first effective time in time domain relating to time-domain resources occupied by the third signaling.

In one embodiment, the first receiver 1601 comprises at least the first four of the antenna 452, the receiver 454, the multi-antenna receiving processor 458, the receiving processor 456 and the controller/processor 459 in Embodiment 4.

In one embodiment, the first transceiver 1602 comprises at least the first six of the antenna 452, the receiver/transmitter 454, the multi-antenna transmitting processor 457, the transmitting processor 468, the multi-antenna receiving processor 458, the receiving processor 456 and the controller/processor 459 in Embodiment 4.

### Embodiment 17

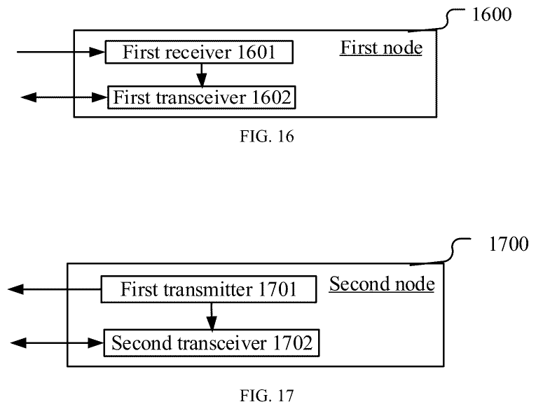

Embodiment 17 illustrates a structure block diagram a processing device in a second node according to one embodiment of the present application, as shown in FIG. 17. In FIG. 17, a second node 1700 comprises a first transmitter 1701 and a second transceiver 1702.

The first transmitter 1701 transmits a first signaling, the first signaling indicating scheduling activation, the first signaling being identified by a first RNTI, the first RNTI being an RNTI of first type; and transmitting a first information block, the first information block being generated at a protocol layer below RRC layer, the first information block being used to determine whether at least one CORESET is associated with a first identity or a second identity;
the second transceiver 1702 determines whether to perform the scheduling activation indicated by the first signaling in at least first time-frequency resource set according to at least the first information block; performs a third operation in the at least first time-frequency resource set according to indication of the first signaling upon determination of performing the scheduling activation indicated by the first signaling in the at least first time-frequency resource set, or does not perform the third operation in the at least first time-frequency resource set upon determination of not performing the scheduling activation indicated by the first signaling in the at least first time-frequency resource set.

In Embodiment 17, each of the first identity and the second identity identifies one cell.

In one embodiment, the first transmitter 1701 transmits a first message; the first message is used to configure at least one RNTI; the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.

In one embodiment, when the at least one RNTI includes/include the RNTI of first type, it is determined that the scheduling activation indicated by the first signaling is performed in the at least first time-frequency resource set; when the at least one RNTI does/do not include the RNTI of first type, whether to perform the scheduling activation indicated by the first signaling in the at least first time-frequency resource set is determined according to at least the first information block.

In one embodiment, when the first information block is used to determine that the at least one CORESET is associated with the first identity, it is determined that the scheduling activation indicated by the first signaling is performed in the at least first time-frequency resource set; when the first information block is used to determine that the at least one CORESET is associated with the second identity, it is determined that the scheduling activation indicated by the first signaling is not performed in the at least first time-frequency resource set.

In one embodiment, the second transceiver 1702 transmits a second information block after the first information block; the second information block is generated at a protocol layer below RRC layer, the second information block being used to determine that at least one CORESET is associated with the first identity; the first information block is used to determine that at least one CORESET is associated with the second identity, and at least the first information block is used to determine that the scheduling activation indicated by the first signaling is not performed in the at least first time-frequency resource set; the second information block is used to determine that the scheduling activation indicated by the first signaling is performed after a second effective time, and the second information block is used to determine the second effective time.

In one embodiment, a second signaling comprises the first information block, and the second signaling also comprises a first field; the first field of the second signaling is used to indicate a HARQ process number used by a radio signal scheduled by the second signaling, or the first field of the second signaling is used to indicate an RV used by a radio signal scheduled by the second signaling; and the first field is not used to suspend or deactivate a PDCCH Validation.

In one embodiment, the second transceiver 1702 receives a third signaling; the third signaling is used to determine the first information block, the first information block being used to determine a first effective time, a position of the first effective time in time domain relating to time-domain resources occupied by the third signaling.

In one embodiment, the first transmitter 1701 comprises at least the first four of the antenna 420, the transmitter 418, the multi-antenna transmitting processor 471, the transmitting processor 416 and the controller/processor 475 in Embodiment 4.

In one embodiment, the second transceiver 1702 comprises at least the first six of the antenna 420, the transmitter/receiver 418, the multi-antenna transmitting processor 471, the multi-antenna receiving processor 472, the transmitting processor 416, the receiving processor 470 and the controller/processor 475 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IoT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station, RSU, unmanned arial vehicle, test equipment like transceiving device simulating partial functions of base station or signaling tester, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling indicating scheduling activation, the first signaling being identified by a first RNTI, the first RNTI being an RNTI of first type; and receiving a first information block, the first information block being generated at a protocol layer below RRC layer, the first information block being used to determine whether at least one CORESET is associated with a first identity or a second identity; and
a first transceiver, determining whether to perform the scheduling activation indicated by the first signaling in at least first time-frequency resource set according to at least the first information block; performing a first operation in the at least first time-frequency resource set according to indication of the first signaling upon determination of performing the scheduling activation indicated by the first signaling in the at least first time-frequency resource set, or not performing the first operation in the at least first time-frequency resource set upon determination of not performing the scheduling activation indicated by the first signaling in the at least first time-frequency resource set;
wherein each of the first identity and the second identity identifies one cell.

2. The first node according to claim 1, characterized in that the first receiver receives a first message, the first message being used to configure at least one RNTI; the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.

3. The first node according to claim 2, characterized in that when the at least one RNTI includes/include the RNTI of first type, it is determined that the scheduling activation indicated by the first signaling is performed in the at least first time-frequency resource set; when the at least one RNTI does/do not include the RNTI of first type, whether to perform the scheduling activation indicated by the first signaling in the at least first time-frequency resource set is determined according to at least the first information block.

4. The first node according to claim 1, characterized in that when the first information block is used to determine that the at least one CORESET is associated with the first identity, it is determined that the scheduling activation indicated by the first signaling is performed in the at least first time-frequency resource set; when the first information block is used to determine that the at least one CORESET is associated with the second identity, it is determined that the scheduling activation indicated by the first signaling is not performed in the at least first time-frequency resource set.

5. The first node according to claim 1, characterized in that the first transceiver receives a second information block after the first information block, the second information block being generated at a protocol layer below RRC layer, the second information block being used to determine that at least one CORESET is associated with the first identity; the first information block is used to determine that at least one CORESET is associated with the second identity, and the first information block is used to determine that the scheduling activation indicated by the first signaling is not performed in the at least first time-frequency resource set; the second information block is used to determine that the scheduling activation indicated by the first signaling is performed after a second effective time, and the second information block is used to determine the second effective time.

6. The first node according to claim 1, characterized in that a second signaling comprises the first information block, and the second signaling also comprises a first field; the first field of the second signaling is used to indicate a HARQ process number used by a radio signal scheduled by the second signaling, or the first field of the second signaling is used to indicate an RV used by a radio signal scheduled by the second signaling; and the first field is not used to suspend or deactivate a PDCCH Validation.

7. The first node according to claim 1, characterized in that the first transceiver transmits a third signaling, the third signaling being used to determine the first information block, the first information block being used to determine a first effective time, a position of the first effective time in time domain relating to time-domain resources occupied by the third signaling.

8. The first node according to claim 1, characterized in that the first information block is used to indicate a TCI.

9. The first node according to claim 1, characterized in that the meaning of the first information block being used to determine whether at least one CORESET is associated with a first identity or a second identity includes at least one of:
the first information block being used to indicate a first identifier, a reference signal associated with the first identifier and a demodulation reference signal in the CORESET being QCL, and the reference signal associated with the first identifier being associated with the first identity or the second identity; or
the first information block being used to indicate a first identifier, a reference signal associated with the first identifier and a PDCCH in the CORESET using identical QCL parameters, and the reference signal associated with the first identifier being associated with the first identity or the second identity.

10. The first node according to claim 1, characterized in that the first information block is used to determine whether the at least one CORESET is associated with the first identity or the second identity after first effective time.

11. The first node according to claim 1, characterized in that the first identity is a PCI of Serving Cell, and the second identity is a PCI other than the PCI of the serving cell.

12. A second node for wireless communications, comprising:
a first transmitter, transmitting a first signaling, the first signaling indicating scheduling activation, the first signaling being identified by a first RNTI, the first RNTI being an RNTI of first type; and transmitting a first information block, the first information block being generated at a protocol layer below RRC layer, the first information block being used to determine whether at least one CORESET is associated with a first identity or a second identity; and
a second transceiver, determining whether to perform the scheduling activation indicated by the first signaling in at least first time-frequency resource set according to at least the first information block; performing a third operation in the at least first time-frequency resource set according to indication of the first signaling upon determination of performing the scheduling activation indicated by the first signaling in the at least first time-frequency resource set, or not performing the third operation in the at least first time-frequency resource set upon determination of not performing the scheduling activation indicated by the first signaling in the at least first time-frequency resource set;
wherein each of the first identity and the second identity identifies one cell.

13. The second node according to claim 12, characterized in that the first transmitter transmits a first message, the first message being used to configure at least one RNTI; the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.

14. The second node according to claim 13, characterized in that when the at least one RNTI includes/include the RNTI of first type, it is determined that the scheduling activation indicated by the first signaling is performed in the at least first time-frequency resource set; when the at least one RNTI does/do not include the RNTI of first type, whether to perform the scheduling activation indicated by the first signaling in the at least first time-frequency resource set is determined according to at least the first information block.

15. The second node according to claim 12, characterized in that when the first information block is used to determine that the at least one CORESET is associated with the first identity, it is determined that the scheduling activation indicated by the first signaling is performed in the at least first time-frequency resource set; when the first information block is used to determine that the at least one CORESET is associated with the second identity, it is determined that the scheduling activation indicated by the first signaling is not performed in the at least first time-frequency resource set.

16. The second node according to claim 12, characterized in that the second transceiver transmits a second information block after the first information block, the second information block being generated at a protocol layer below RRC layer, the second information block being used to determine that at least one CORESET is associated with the first identity; the first information block is used to determine that at least one CORESET is associated with the second identity, and the first information block is used to determine that the scheduling activation indicated by the first signaling is not performed in the at least first time-frequency resource set; the second information block is used to determine that the scheduling activation indicated by the first signaling is performed after a second effective time, and the second information block is used to determine the second effective time.

17. The second node according to claim 12, characterized in that a second signaling comprises the first information block, and the second signaling also comprises a first field; the first field of the second signaling is used to indicate a HARQ process number used by a radio signal scheduled by the second signaling, or the first field of the second signaling is used to indicate an RV used by a radio signal scheduled by the second signaling; and the first field is not used to suspend or deactivate a PDCCH Validation.

18. The second node according to claim 12, characterized in that the second transceiver receives a third signaling, the third signaling being used to determine the first information block, the first information block being used to determine a first effective time, a position of the first effective time in time domain relating to time-domain resources occupied by the third signaling.

19. A method in a first node for wireless communications, comprising:
receiving a first signaling, the first signaling indicating scheduling activation, the first signaling being identified by a first RNTI, the first RNTI being an RNTI of first type; and receiving a first information block, the first information block being generated at a protocol layer below RRC layer, the first information block being used to determine whether at least one CORESET is associated with a first identity or a second identity; and
determining whether to perform the scheduling activation indicated by the first signaling in at least first time-frequency resource set according to at least the first information block; performing a first operation in the at least first time-frequency resource set according to indication of the first signaling upon determination of performing the scheduling activation indicated by the first signaling in the at least first time-frequency resource set, or not performing the first operation in the at least first time-frequency resource set upon determination of not performing the scheduling activation indicated by the first signaling in the at least first time-frequency resource set;
wherein each of the first identity and the second identity identifies one cell.

20. The method in the first node according to claim 19, characterized in comprising:
receiving a first message;
wherein the first message being used to configure at least one RNTI; the first information block is used to determine that the at least one CORESET is associated with the second identity, and the first information block is used to determine that the at least one RNTI is applied in the at least one CORESET; whether the at least one RNTI includes/include the RNTI of first type is used to determine whether to perform the scheduling activation indicated by the first signaling in the at least first time-frequency resource set.
